(19) United States
(12) Patent Application Publication
(10) Pub. No.: US 2024/0384111 A1
(43) Pub. Date: Nov. 21, 2024

(54) METHODS FOR PRODUCING AN ORGANOMETALLIC COATING AND APPLYING AN ORGANOMETALLIC COATING TO METAL PARTS, AND ORGANOMETALLIC COATING

(71) Applicant: CIA. INDUSTRIAL H. CARLOS SCHNEIDER, Joinville (BR)

(72) Inventor: Marcelo Da Silva GOMES, São Paulo (BR)

(21) Appl. No.: 18/689,564

(22) PCT Filed: Sep. 2, 2022
(86) PCT No.: PCT/BR2022/050351

§ 371 Date: Mar. 6, 2024

(30) Foreign Application Priority Data
Sep. 6, 2021 (BR) 102021017707-1

(51) Int. Cl. C09D 5/10; C09D 7/40; C09D 7/62; C09D 7/80

(52) U.S. Cl. CPC C09D 5/106; C09D 5/103; C09D 7/62; C09D 7/66; C09D 7/80

(57) ABSTRACT

The present invention is related to a method for obtaining an organometallic (zinc flake) coating in an aqueous solution. More specifically, the present invention is related to obtaining a zinc flake type coating comprising a nanometric colloidal silica layer. Within the scope, the present invention suggests a method for obtaining a coating for metallic parts with improved surface hardness and high performance against corrosion. The present invention is further related to a method for applying the organometallic coatings thus obtained to metal parts and to the organometallic coatings.

### FIELD OF THE INVENTION

The invention is related to a method for producing a zinc flake-based organometallic coating in an aqueous solution, more specifically, the present invention is related to the production of a zinc flake like coating containing a small percentage of aluminum (containing 10 to 20% metallic zinc and 1 to 5% metallic aluminum). More specifically, the present invention teaches a method for obtaining a coating for metal parts with improved surface hardness and high performance against corrosion.

The present invention further refers to the organometallic coatings obtained by means of said process and to applying same to metal parts.

### BACKGROUND OF THE INVENTION

Organometallic coatings stand out in the field of coatings for metal parts relative to the electrolytic coatings since they are not susceptible to hydrogen embrittlement. Within the scope of organometallic coatings, there are notable efforts directed to the development of technologies that are free from heavy metals and environmentally friendly. In this context, the state of the art discloses organometallic coatings in an aqueous base such as, for example, Geomet® 321/720, which consists of an aqueous dispersion comprising zinc and aluminum flakes and other specific chemical agents and is especially formulated for protecting substrates of iron, aluminum, zinc, and the alloys thereof.

However, conventional organometallic coatings, despite the high resistance thereof to corrosion, present low surface hardness and resistance to bad weather conditions. Referring to zinc flake type coatings, the zinc and aluminum flakes provide a film without sufficient rigidity to offer metallic resistance for certain applications. Thus, the formation of pores originating from the alignment between the zinc and aluminum particles favors the penetration of bad weather conditions. This technical problem is evident even in light of the application of several layers of coating and even in light of the use of topcoats (sealants).

Within this scope, the state of the art covers documents which aim at the improvement of the mechanical properties of coatings. For example, the Mora, L.V. thesis evaluates the incorporation of nanoparticles in coatings for metallic structures. This document discloses the incorporation of functionalized and non-functionalized silica nanoparticles in a sol-gel coating and polysiloxane matrix. It was demonstrated that the incorporation of said nanofillers in the matrix enables obtaining coatings with improved mechanical properties. Moreover, this document mentions the relevance of the dispersion of nanoparticles within the matrix to achieve improved mechanical properties. However, the document in question is silent about organometallic zinc and aluminum coatings and, consequently, about aqueous-based organometallic coatings of this nature.

Document CN102344738A discloses a composite coating composition against corrosion for steel structures which comprises flaked zinc powder as sacrificial electrode and inorganic nanofiller. Said inorganic nanofiller can consist of silicon oxide. However, this document proposes, apart from a coating with high corrosion resistance, a solution to the problem of substrate adhesion related to the conventional coatings rich in zinc. For this purpose, the document in question teaches the production of an epoxy resin and flaked zinc powder-based coating, in the presence of a mixed xylenol and n-butanol solvent.

Document CN1563229A, in its turn, refers to a zinc flake coating comprising powder nanofiller which can consist of nano-silica. This document proposes zinc flake as an alternative to conventional zinc powder paints by pointing out several advantages and, within this scope, it mentions that the flake structure of the zinc flake type alloys is satisfactory relative to the penetration of bad weather conditions and corrosive mediums. In this manner, this document does not contain explicit teachings about incorporating the nanofiller to fill pores and reduce bad weather conditions. Additionally, the coating as described in this document is not water-soluble and, in accordance with the explicit process for obtaining same, the preparation of the coating is carried out with organic solvents and epoxy resin. It is worth mentioning that the coating in question is designed for concrete, and not metal parts.

As cited above, the state of the art does not provide teachings concerning improving the mechanical properties, such as increase of surface hardness and abrasion resistance, of zinc and aluminum organometallic coatings. Moreover, the state of the art is silent over incorporating nanometric colloidal silica in an aqueous-based organometallic compound matrix. In this scenario, the present invention provides a method which allows obtaining an organometallic coating having high surface hardness and excellent resistance to corrosion, apart from being environmentally friendly by waiving the use of epoxy resins and organic solvents.

In this manner, there are reports in the state of the art which anticipate a process for obtaining a lamellar zinc based organometallic coating in an aqueous solution with mechanical resistance characteristics and anti-corrosion greater than the coatings known to the state of the art.

### SUMMARY OF THE INVENTION

The present invention is related to a method for obtaining a lamellar zinc organometallic coating in an aqueous solution. More specifically, the present invention is related to a method for producing an aqueous-based zinc flake matrix coating, comprising incorporating the nanometric colloidal silica filler in an aqueous and/or alcoholic solution. The method that is the object of the present invention can additionally comprise incorporating nano and/or micro stainless steel powder particles 316-L or 304, fiberglass powder, micronized glass powder or mixtures thereof.

The present invention has the purpose of providing a processing route for producing an organometallic coating having surface hardness and corrosion resistance higher than the organometallic coatings currently in use.

Additionally, the present invention aims at obtaining an organometallic coating free of organic solvents and epoxy resins, thus configuring an environmentally friendly proposal.

In order to reach the above described objectives, the present invention foresees a route for producing a high quality organometallic coating in an aqueous base. Said method comprises:
a) mixture of parts A (zinc and aluminum paste), B (aqueous medium) and C (viscosity agent); and
b) in medium agitation, gradually adding the colloidal silica solution and proceeding with agitation for at least 1 hour.

Moreover, the present invention proposes a method for applying the organometallic coating obtained for application on metal parts. Preferably, the invention is related to applying said coating by means of conventional immersion and centrifugation methods, spray or immersion and draining. The method of applying the coating of the present invention comprises a cure step at a temperature in the range of 320° C. to 335° C. for a period between 15 and 30 minutes.

Optionally, the present invention proposes applying a sealant based on colloidal silica nanoparticles, aiming at increasing even more the resistance to corrosion and bad weather conditions.

These objectives and remaining advantages of the present invention will be more evident from the following description.

### BRIEF DESCRIPTION OF THE FIGURES

FIG. 1 illustrates an image obtained by scanning electron microscopy (SEM) of a film of conventional organometallic coating.

FIG. 2 illustrates an image obtained by scanning electron microscopy (SEM) of a film of conventional organometallic coating with a colloidal nanometric silica filler according to the present invention (with an increase of 2.500×).

FIG. 3 illustrates an image obtained by scanning electron microscopy (SEM) of a film of conventional organometallic coating with a colloidal nanometric silica filler according to the present invention (with an increase of 10.000×).

FIG. 4 illustrates images of metallic surfaces with and without application of sealing layer based on colloidal silica nanoparticles after 3.000 h salt spray test.

### DETAILED DESCRIPTION OF THE INVENTION

The present invention is related to producing an organometallic coating in an aqueous base including incorporating a nanometric colloidal silica filler.

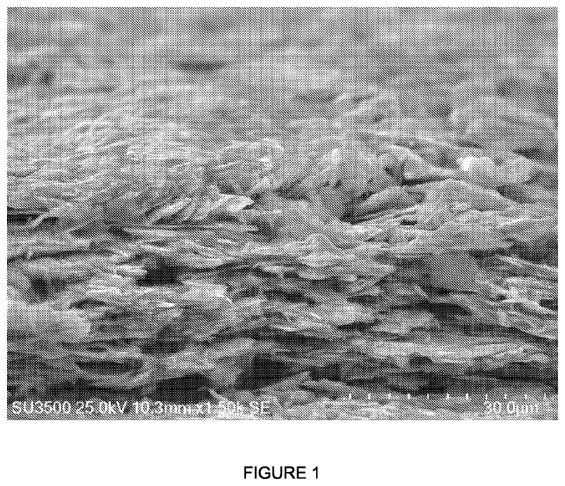

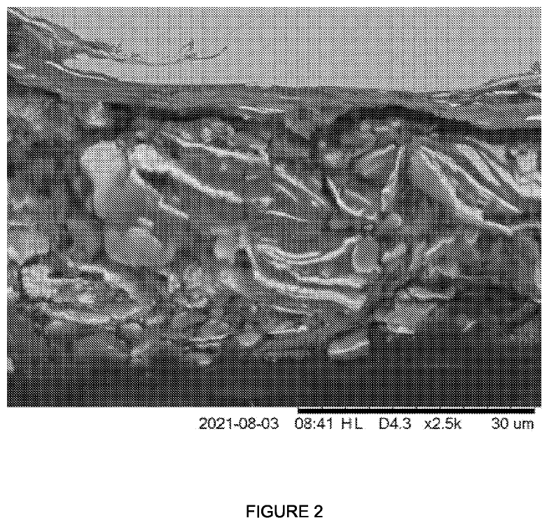

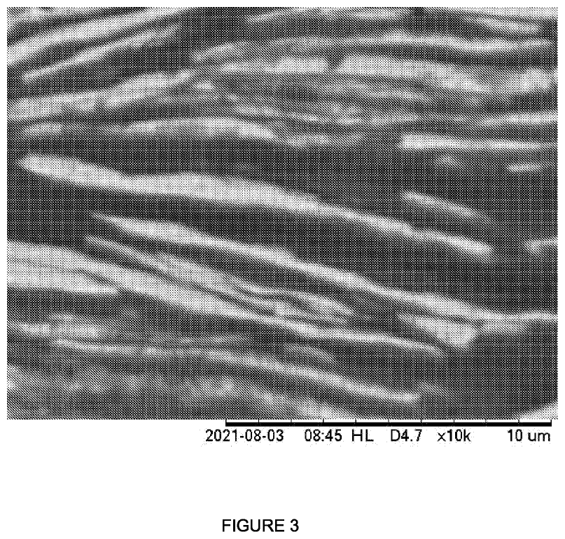

The colloidal silica mixes much more easily with the organometallic matrix, in comparison with the powder substance. In a preferred embodiment of the present invention, there are further incorporated fillers of stainless steel powder 316-L or 304 nano and/or micro particles, fiberglass powder, micronized glass powder or mixtures thereof. The nano and micro particles of said materials are inert and do not alter the organometallic matrix and contribute positively to increasing the surface hardness and resistance to corrosion, abrasion, and bad weather conditions. In this way, a rigid coating structure is obtained, with a “structural support” for the zinc and aluminum particles in the organometallic matrix. FIGS. 2 and 3 demonstrate the reduction of coating porosity of the zinc flake coating when incorporated with a colloidal silica filler in comparison with a conventional organometallic coating as illustrated in FIG. 1. According to the present invention, colloidal silica contains particles of 10 to 50 nm and consists of a solution comprising 15 to 32% colloidal silica, 6 to 8% of 2-butoxyethanol, 6 to 10% methanol and 50 to 63% water.

The method for producing the organometallic coating constituted by an aqueous-based zinc flake matrix containing nanometric colloidal silica filler comprises the following steps:
a) mixing parts A (zinc and aluminum paste), B (aqueous medium) and C (viscosity agent), wherein part B is added little by little to previously homogenized part A, and, next, part C is added little by little to the mixture of parts A and B and, then, the mixture is agitated for 24 hours in a mechanical stirrer with centrifugal propeller with stirring speed not higher than 3.000 rpm, wherein
part A comprises 20 to 40% metallic zinc, 2 to 10% metallic aluminum, 20 to 30% dipropylene glycol, 2 to 5% non-ionic surfactant and 15 to 20% deionized water;
part B comprises 1 to 7% silane (A-187), 70 to 90% deionized water, 0.1 to 0.2% boric acid and 2 to 3% sodium silicate; and
part C comprises a water-based paint thickener of the group consisting of hydroxycellulose, guar gum, fumed silica and polynvinyl alcohol, in addition to thixotropy agents, such as modified bentonites (organophilic clays);
wherein parts A, B and C are mixed in a proportion of about 42% by weight of A, about 57% by weight of B and between about 0.3 and about 0.7% by weight of C, based on the total weight of the zinc flake matrix,
wherein part C is added in the established range until the viscosity of the mixture is in the range of 60 to 80, according to Zahn cup no. 2; and
b) in medium agitation, add little by little about 15% to about 20% by weight, of the colloidal silica solution, relative to the total weight of the coating composition, and proceed with stirring for at least 1 hour in mechanical stirrer with centrifugal propeller with stirring speed not higher than 3.000 rpm.

The fillers of nano and/or micro particles of stainless steel powder 316-L or 304, fiberglass powder, micronized glass powder or mixtures thereof, when incorporated, are added in the following proportions: 1 to 5% nano and/or micro particles of stainless steel powder 316-L or 304, 1 to 5% fiberglass powder and 1 to 5% micronized glass powder, wherein all proportions are by weight relative to the colloidal silica weight. Said additional fillers are incorporated to the silica and the mixture is vigorously stirred for 30 minutes in mechanical stirrer with centrifugal propeller and, next, left to rest for 8 to 12 minutes. After the rest/decantation period, only the suspended particles are used.

Additionally, the present invention is related to a method for applying the obtained organometallic coating to applications in metal parts. Said application method comprises a preliminary step of alkaline degreasing of the parts for removal of oils and any other types of contaminants. Next, the parts are washed in hot water for removal of residue of the degreaser. Then, the parts are submitted to abrasive blasting with stainless steel microspheres for removal of undesired impurities from the substrate surface, in addition to improving the surface metallurgical qualities. Finally, the application of the organometallic coating is carried out by means of conventional immersion and centrifuging processes, spray or immersion and draining and comprises the following steps:
immersion in bath for 15 to 30 seconds;
centrifuging between 250 rpm and 450 rpm for 15 to 30 seconds in each direction, clockwise and anti-clockwise;
curing at a temperature of 320° C. to 335° C. for 15 to 30 minutes.

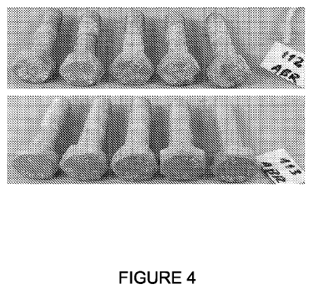

According to the invention, the coating can be applied to the parts in up to 3 layers, so that the final coating layer (“total layer”) has between 5 and 12 microns. Within this scope, the present invention enables up to 3.000 h resistance to corrosion without the application of a sealant based on colloidal silica nanoparticles and up to 8.000 h resistance to corrosion with the application of a layer of sealant, according to the salt spray test, in accordance with ASTM B-117 and ISO 9227 specifications. FIG. 4 demonstrates the results reached in terms of the visual aspect which can be observed, for a set of metal parts coated with the “total layer” of organometallic coating of the present invention and for a set of metal parts comprising an additional layer of sealant, both submitted to a salt spray test for 3.000 h.

The description made up to now of the present invention must be considered solely as one or more possible embodiments, and any particular characteristics introduced therein must be understood only as something that was described to facilitate understanding. In this way, they must not be considered as limitations of the invention, which is limited to the scope of the claims.

The example which will be presented illustrate the scope of the invention proposed herein.

### EXAMPLE

### Example 1: Salt Spray Test

A salt spray test was carried out in conformity with the ASTM B-117 and ISO 9227 specifications, during 3.000 h, in two sets of samples of metal parts: the first set coated with the “total layer” of coating according to the invention and the second set with the application of an additional layer of sealant based on colloidal silica nanoparticles.

1. Method for obtaining an organometallic coating, characterized by the fact that it comprises the steps of:
a) mixing parts A (zinc and aluminum paste), B (aqueous medium) and C (viscosity agent), wherein part B is added little by little to previously homogenized part A, and, next, part C is added little by little to the mixture of parts A and B and, then, the mixture is agitated for 24 hours in a mechanical stirrer with centrifugal propeller with stirring speed not higher than 3.000 rpm, wherein
part A comprises 20 to 40% metallic zinc, 2 to 10% metallic aluminum, 20 to 30% dipropylene glycol, 2 to 5% non-ionic surfactant and 15 to 20% deionized water;
part B comprises 1 to 7% silane (A-187), 70 to 90% deionized water, 0.1 to 0.2% boric acid and 2 to 3% sodium silicate; and
part C comprises a water-based paint thickener of the group consisting of hydroxycellulose, guar gum, fumed silica and polynvinyl alcohol, in addition to thixotropy agents,
wherein parts A, B and C are mixed in a proportion of about 42% by weight of A, about 57% by weight of B and between about 0.3 and about 0.7% by weight of C, based on the total weight of A+B+C,
wherein part C is added in the established range until the viscosity of the mixture is in the range of 60 to 80, according to Zahn cup no. 2; and
b) in medium agitation, add little by little about 15% by weight, of the colloidal silica solution, relative to the total weight of the coating composition, and proceed with stirring for at least 1 hour in mechanical stirrer with centrifugal propeller with stirring speed not higher than 3.000 rpm,
wherein the colloidal silica solution comprises from 15 to 32% colloidal silica, 6 to 8% 2-butoxyethanol, 6 to 10% methanol and 50 to 63% water.

2. Method for obtaining an organometallic coating, according to claim 1, characterized by the fact that the colloidal silica has particles of 10 to 50 nm.

3. Method for obtaining an organometallic coating, according to claim 1, characterized by the fact that it comprises an additional step of incorporating additional fillers of nano and/or micro particles of stainless steel powder 316-L or 304, fiberglass powder, micronized glass powder, or mixtures thereof, wherein said additional step is carried out before step b).

4. Method for obtaining an organometallic coating, according to claim 3, characterized by the fact that said additional fillers are incorporated to the colloidal silica solution in the following proportions: 1 to 5% nano and/or micro stainless steel particles 316-L or 304, 1 to 5% fiberglass powder and 1 to 5% micronized glass powder, all proportions being by weight relative to the colloidal silica weight.

5. Method for obtaining an organometallic coating according to claim 4, characterized by the fact that the mixture of additional fillers and silica is vigorously stirred for 30 minutes in mechanical stirrer with centrifugal propeller and, next, left to rest for 8 to 12 minutes.

6. Method for applying an organometallic coating as defined in claim 1 to metal parts, characterized by the fact that it comprises:
alkaline degreasing of the metal parts;
washing of the metal parts in hot water;
abrasive blasting of the metal parts with stainless steel microspheres;
immersion of the metal parts in organometallic coating bath for 15 to 30 seconds;
centrifuging between 250 rpm and 450 rpm for 15 to 30 seconds in each direction, clockwise and anti-clockwise; and
curing at a temperature of 320° C. to 335° C. for 15 to 30 minutes.

7. Method for applying an organometallic coating to metal parts, according to claim 6, characterized by the fact that the coating can be applied to the parts in up to 3 layers.

8. Method for applying an organometallic coating to metal parts, according to claim 6, characterized by the fact that it additionally comprises applying a sealant based on colloidal silica nanoparticles.

9. Organometallic coating, characterized by the fact that it is obtainable by the method as defined in claim 1, wherein the final layer of the coating has between 5 and 12 microns.
